(19) United States
(12) Patent Application Publication
(10) Pub. No.: US 2005/0027614 A1
(43) Pub. Date: Feb. 3, 2005

(54) Fractional private aircraft auction system and method

(75) Inventor: Nathan W. McKelvey, Hingham, MA (US)

Correspondence Address: PALMER & DODGE, LLP;RICHARD B. SMITH, 111 HUNTINGTON AVENUE, BOSTON, MA, 02199, US

(73) Assignee: ChaterAuction.com

(21) Appl. No.: 10/898,395

(22) Filed: Jul. 23, 2004

Related U.S. Application Data
(60) Provisional application No. 60/490,056, filed on Jul. 25, 2003.

(51) Int. Cl. G06F 17/60

(52) U.S. Cl. 705/26

(57) ABSTRACT

A fractional private aircraft auction for auctioning a flight on a fractional private charter aircraft comprises an online auction interface to receive a trip itinerary request from a customer; a calculation mechanism to calculate a duration of the flight for the trip itinerary; a query mechanism to obtain, from a fractional aircraft owner database, a set of suitable fractional aircraft owners to serve the trip itinerary based on the duration of the flight from the calculation mechanism; and an online bidding interface to receive the bids corresponding to the suitable fractional aircraft owners from the query mechanism. A transaction mechanism processes a transaction for the trip itinerary if a customer completes the transaction by selecting one of the bids from the fractional aircraft owners.

### RELATED APPLICATIONS

This application claims the benefit of Provisional Application Ser. No. 60/490,056, filed Jul. 25, 2003, the entirety of which is hereby incorporated herein by reference.

### FIELD OF THE INVENTION

Aspects of the present invention relate to private jet auctions, in particular to a system and method for a fractional private aircraft auction.

### BACKGROUND OF THE INVENTION

There are many types of online auctions on the Internet for a wide range of products. Some of these companies include ebay.com, a person-to-person auction site, and priceline.com, an auction site for travel and related products between customers and travel companies in which the customer places bids on desired items. These websites all have online auction interfaces for one party to enter information regarding the product of service they would like to sell, and for another party to enter a bid on that product or service.

Private charter aircraft auctions pair customers with charter aircraft through online auction systems. By way of example, published U.S. patent application US 2002/0013718 A1 discloses a method and system for reserving air charter aircraft. Published U.S. Patent application US 2002/0019756 A1 discloses a charter aircraft network, organization, reservation, and flight processing system and method. Published U.S. Patent application US 2002/0194037 A1 discloses a method and apparatus for the arranging of flexible and cost-efficient private air travel.

### SUMMARY OF THE INVENTION

In accordance with one aspect, the present invention may be directed to a system or method for carrying out a fractional private aircraft auction or to any one or combination of parts of such a system or method. In one embodiment, fractional aircraft owners post bids with minimum bidding information for their flight hours, and customers can bid on these flight hours. In another embodiment, customers access an online auction interface and enter a trip itinerary comprising a request for a certain number of flight hours. Fractional aircraft owners can place bids on a given trip itinerary through an online bidding interface. In another embodiment, fractional aircraft owners submit information regarding available flight hour and price information, and customers submit information regarding a requested flight and a maximum price they will pay for the required flight hours. Flight requests from the customer are matched with the information provided by the fractional aircraft owners.

The present invention is a system for auctioning a flight on a fractional private charter aircraft comprising an online auction interface to receive a trip itinerary request from a customer; a calculation mechanism to calculate a duration of the flight for the trip itinerary; a query mechanism to obtain, from a fractional aircraft owner database, a set of suitable fractional aircraft owners to serve the trip itinerary based on the duration of the flight from the calculation mechanism; and an online bidding interface to receive the bids corresponding to the suitable fractional aircraft owners from the query mechanism.

The present invention is a method for auctioning a flight on a fractional private charter aircraft comprising: receiving a trip itinerary request from a customer by an online auction interface; calculating a duration of a flight for the trip itinerary; obtaining, from a fractional aircraft owner database, a set of suitable fractional aircraft owners to serve the trip itinerary based on the duration of the flight; receiving, at an online bidding interface, bids on the trip itinerary from the suitable fractional aircraft owners; and processing a transaction for the trip itinerary if the customer completes the transaction by selecting one of the bids from the fractional aircraft owners.

The present invention is a computer readable medium containing program instructions for auctioning a flight on a fractional private charter aircraft comprising: program instructions for receiving a trip itinerary request from a customer with an online auction interface; program instructions for calculating a duration of the flight for the trip itinerary; program instructions for obtaining, from a fractional aircraft owner database, a set of suitable fractional aircraft owners to serve the trip itinerary based on the duration of the flight from a calculation mechanism; program instructions for receiving a set of bids from the suitable fractional aircraft owners from an online bidding interface; and program instructions for processing a transaction for the trip itinerary if a customer completes the transaction by selecting one of the bids from the fractional aircraft owners.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 is a system diagram of an embodiment of a fractional aircraft auction system.

FIG. 2 is a diagram of an embodiment of a fractional aircraft auction comprising the posting of bids from fractional aircraft owners with minimum bidding information, and bidding on the postings by customers.

FIG. 3 is a diagram of another embodiment of a fractional aircraft auction comprising a customer submitting trip itinerary information and fractional aircraft owners submitting bids on a given trip itinerary.

FIG. 4 is a diagram of another embodiment of a fractional aircraft auction comprising the submission of flight hour and price information from fractional aircraft owners and trip itinerary and price information from customers.

FIG. 5 is a block diagram of a representative computer system.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and spirit of the principles of the present invention.

### DETAILED DESCRIPTION

A fractional aircraft owner is one who owns a share of a private aircraft through the purchase of flight hours. There are a number of aircraft management companies that sell flight time to customers, who in turn become fractional owners of the aircraft. The aircraft are flown and managed by these aircraft management companies. Aircraft management companies allow clients to purchase shares of aircraft by selecting an aircraft type and number of flight hours per year, and the clients pay monthly management and usage fees to maintain the aircraft, the flight crews, hangars, fuel, and flight insurance.

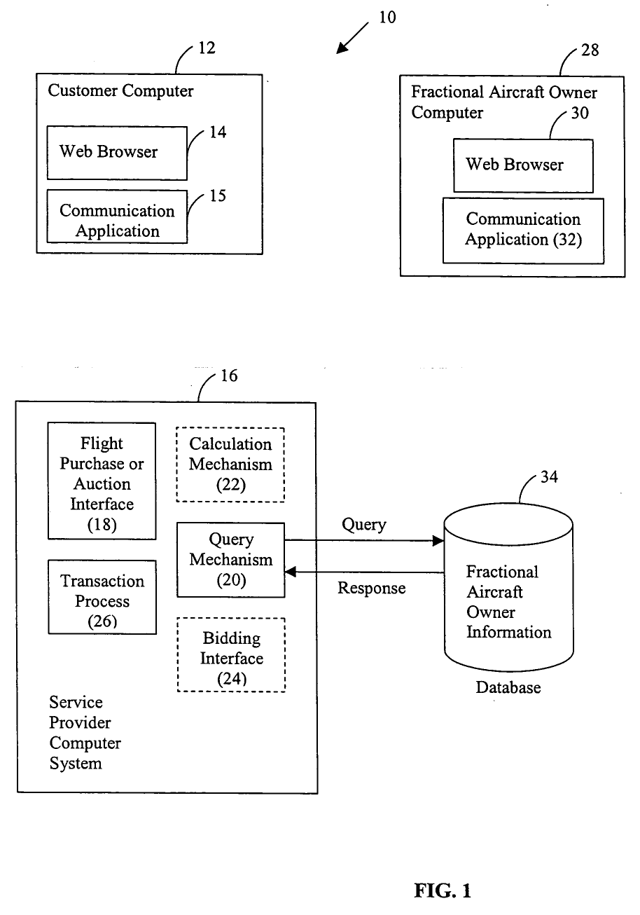

Referring now to the drawings in greater detail, FIG. 1 illustrates a fractional aircraft owner auction system 10. The illustrated system 10 comprises a service provider computer system 16, coupled to a customer computer 12 and a fractional aircraft owner computer 28. Customer computer 12 and fractional aircraft owner computer 28 may each be coupled to service provider computer system 16 via the Internet. Fractional aircraft owner auction system 10 further comprises a database 34 comprising fractional aircraft owner information.

Customer computer 12 comprises a web browser 14 and a communication application 15. In a preferred embodiment of the present invention, the communication application is electronic mail (email). Fractional aircraft owner computer 28 comprises a web browser 30 and a communication application 32.

“Communication” as used herein with respect to communication, communication application and communication mechanism includes, but is not limited to, electronic mail (email), instant messaging, use of a personal digital assistant (PDA), a pager, a fax, a cellular telephone, a conventional telephone, television, video telephone conferencing display, other types of radio wave transmitter/transponders and other forms of electronic communication. In a preferred embodiment of the present invention, communication refers to email. Those skilled in the art will recognize that other forms of communication known in the art are within the spirit and scope of the present invention.

Service provider computer system 16 comprises a flight purchase or auction interface 18, a query mechanism 20, a calculation mechanism 22, a bidding interface 24, and a transaction process 26.

A system and method for private charter aircraft auction is described in the Assignee's co-pending patent application U.S. Ser. No. 00/000,000 filed Jul. 23, 2004 (Attorney Docket No. 18148/2002), and the entirety of this application is hereby incorporated herein by reference.

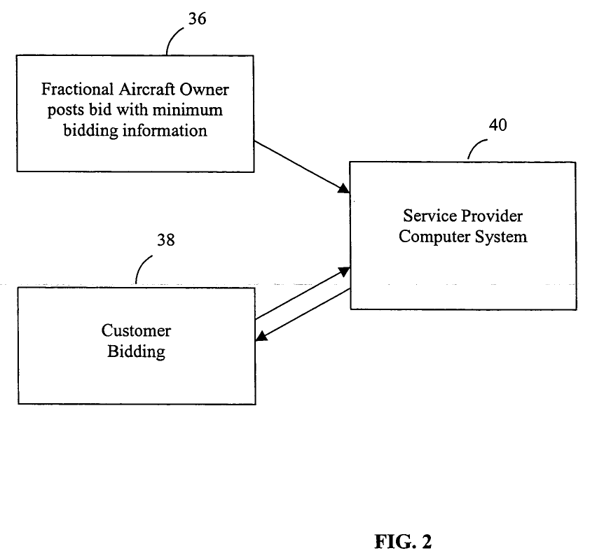

FIG. 2 is a diagram of an embodiment of the fractional aircraft owner auction comprising the posting of bids from fractional aircraft owners with minimum bidding information, and the bidding on the postings by customers. In this embodiment, a fractional aircraft owner posts a bid with information regarding a minimum price for their flight hours, in step 36. This minimum value becomes the starting price for the fractional aircraft owner auction. In operation, a fractional aircraft owner will operate fractional aircraft owner computer 28, and enter the minimum bidding information through the use of web browser 30. Specifically, bidding interface 24 of service provider computer system 16 will present a bidding interface on web browser 30 of fractional aircraft owner computer 28, and the user of fractional aircraft owner computer 28 will input certain information regarding a minimum price for their flight hours to set the starting price for the auction. The bid is sent to service provider computer system 40 as shown in FIG. 2.

Customers can bid on fractional aircraft owner auction in step 38. Customers can view the fractional aircraft owner auction information on web browser 14 of customer computer 12. For example, at the start of a new auction, a fractional aircraft owner submits minimum bidding information comprising 5 flight hours at a minimum bid of $1000. A customer can submit a bid on this auction starting at a bid of $1000. As customers submit bids on a particular auction, the price increases until the bidding process ends after a specified amount of time has passed.

The transaction process 26 processes the transaction when the auction is complete. A notification mechanism contacts the customer by a communication mechanism which sends a communication to communications application 15 in customer computer 12. This communications notifies the customer that they have won the given auction. A confirmation mechanism contacts the customer by a communication mechanism which sends a communication confirming the booking of the aircraft. A transaction mechanism processes the payment for the flight from the customer.

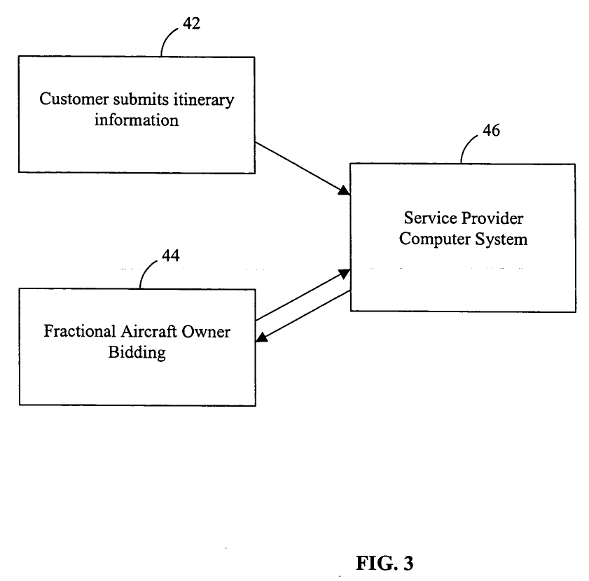

FIG. 3 is a diagram of another embodiment of the fractional aircraft owner auction of the present invention. In this embodiment, a customer submits itinerary information in step 42. In operation, a user will operate customer computer 12, and enter a trip itinerary through the use of web browser 14. Specifically, flight purchase or auction interface 18 of service provider computer system 16 will present an auction interface on web browser 14 of customer computer 12, and the user of customer computer 12 will input certain information regarding a trip itinerary concerning the user's desire to purchase a certain number of flight hours on a private charter aircraft. This trip itinerary information is sent to service provider computer system 46 in FIG. 3.

Fractional aircraft owners can bid on the auction in step 44 through bidding interface 24. Fractional aircraft owners can view the trip itinerary information on web browser 30 of fractional aircraft owner computer 28. For example, at the start of a new auction, a customer submits a trip itinerary comprising a request for 5 flight hours. A fractional aircraft owner views this trip itinerary on web browser 30 of fractional aircraft owner computer 28, and can submit a bid on the auction for the given trip itinerary comprising price that the given fractional aircraft owner will accept for the number of flight hours requested. As fractional aircraft owners submit bids on a particular auction for a given trip itinerary, the price decreases until the bidding process ends after a specified amount of time has passed.

The transaction process 26 processes the transaction if the customer chooses one of the bids. A notification mechanism contacts the fractional aircraft owner by a communication mechanism which sends a communication to a communication application 32 in a fractional aircraft owner computer 28. This communication notifies the fractional aircraft owner that they have been chosen to fulfill the given trip itinerary. A confirmation mechanism contacts the customer by a communication mechanism which sends a communication to communication application 15 confirming the booking of the aircraft. A transaction mechanism processes the payment for the flight from the customer.

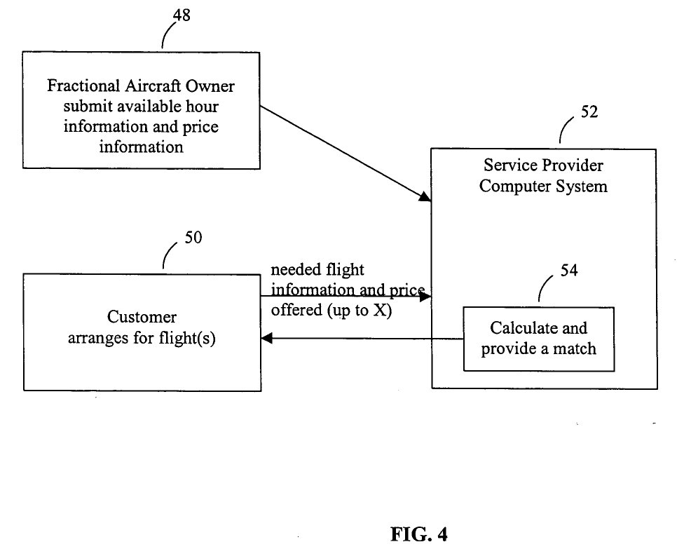

FIG. 4 is a diagram of another embodiment of the fractional aircraft owner auction of the present invention. In this embodiment, a fractional aircraft owner submits available hour and price information in step 48. This information comprises the number of available flight hours and the price set for each flight hour. This information is sent to a service provider computer system 52. A customer sends to service provider computer system 52 needed flight information and a price offered, up to a certain amount, in step 50. This information comprises a trip itinerary and a maximum value the customer will pay for each flight hour. The service provider computer system 52 then compares the customer request to available hours and price information submitted by the fractional aircraft owners and calculates and provides a match in step 54.

In one embodiment, the trip itinerary comprises a request for a certain number of flight hours. This information can be sent directly to database 34 and used to find suitable fractional aircraft owners to fulfill the given trip itinerary, where suitable fractional aircraft owners comprises fractional aircraft owners with enough flight hours to fulfill the given trip itinerary.

In another embodiment, the trip itinerary comprises departure and destination locations, dates of travel, and a requested aircraft type. Calculation mechanism 22 of service provider computer system 16 uses the trip itinerary information regarding departure and destination locations to calculate a duration of the flight. The duration is the number of flight hours needed to fulfill the given trip itinerary. The information regarding the number of flight hours needed to fulfill the given trip itinerary is sent to database 34 and used to find suitable fractional aircraft owners to fulfill the given trip itinerary, where suitable fractional aircraft owners comprises fractional aircraft owners with enough flight hours to fulfill the given trip itinerary.

The set of suitable fractional aircraft owners are sent from database 34 back to service provider computer system 16. Service provider computer system 16 matches the given customer trip itinerary with a suitable fractional aircraft owner.

The transaction process 26 processes the transaction when a match between a customer and a fractional aircraft owner is made. A notification mechanism contacts the fractional aircraft owner by a communication mechanism which sends a communication to communication application 32 in fractional aircraft owner computer 28. This communication notifies the fractional aircraft owner that they have been chosen to fulfill the given trip itinerary. A confirmation mechanism contacts the customer by a communication mechanism which sends a communication confirming the booking of the aircraft. A transaction mechanism processes the payment for the flight from the customer.

The processing performed by the system described herein may be integrated into dispatching software. Dispatching software provides a continuous communication link to facilitate the fractional aircraft auction. Dispatching software is used for scheduling of the aircraft and quoting the aircraft. Quoting the aircraft involves using software to load into the database all of the aircraft specifications, such as speed of the aircraft, the cost of the fuel and all the other components.

The dispatching software downloads the list of trip itineraries and compares those trip itineraries against availability and automatically provides a quote for each itinerary. To submit a bid, the dispatching software downloads the requests for quotes (“RFQs”), compares the RFQs, and quotes them automatically. The user then chooses an itinerary out of all the possible matches and accepts the chosen bid.

The processing performed by the system described herein may be performed by a general purpose computer alone or in connection with a specialized processing computer. Such processing may be performed by a single platform or by a distributed processing platform. In addition, such processing and functionality can be implemented in the form of special purpose hardware or in the form of software being run by a general purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

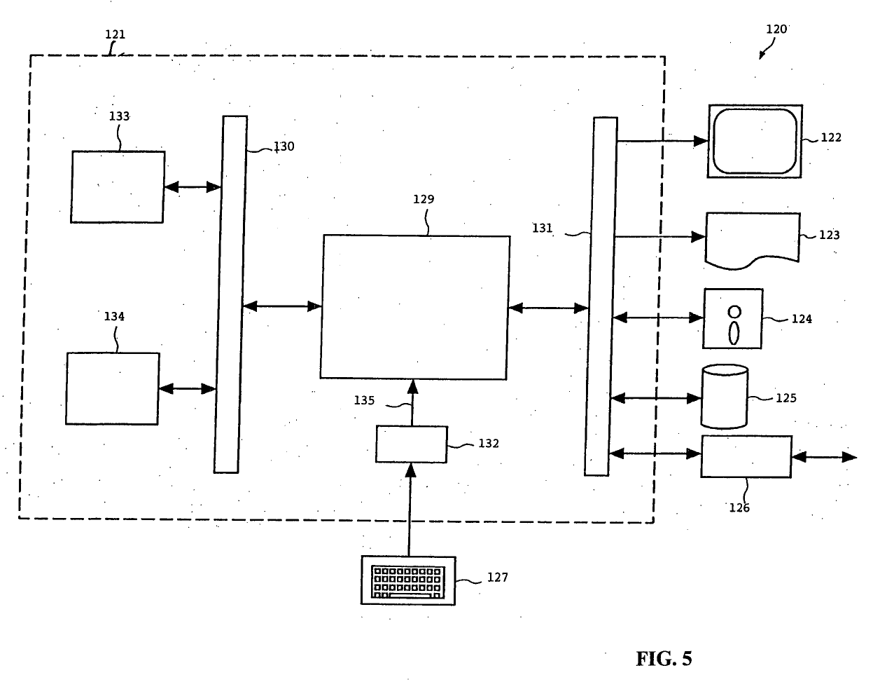

For example, a block diagram of a representative computer system 120 is shown in FIG. 5. In another embodiment of the present invention, the computer system is an embedded computer system. The computer system 120 includes a computer 121, a display screen (or monitor) 122, a printer 123, a floppy disk drive 124, a hard disk drive 125, a network interface 126 and a keyboard 127. The computer 121 includes a microprocessor 129, a memory bus 130, a peripheral bus 131 and a keyboard controller 132. The keyboard 127 is used by a user to input commands and other instructions to the computer system 120. The keyboard controller 132 receives input from the keyboard 127 and sends decoded symbols for each pressed key of the keyboard 127 to the microprocessor 129 over a bus 135. The computer 121 can be a personal computer, a workstation or some other type of computer.

The microprocessor 129 controls the operation of the computer system 120. The microprocessor 129 uses instructions received from memory and outputs and displays the data on output devices. The keyboard 127 is used by a user to input commands and other instructions to the computer system 120. The memory bus 130 is used by the microprocessor 129 to access a random access memory (RAM) 133 and a read only memory (ROM) 134. The RAM 133 is used by the microprocessor 129 as a general storage area and the ROM 134 is used to store the instructions or program code followed by the microprocessor 129. The computer code and data may reside on the RAM 133, the ROM 134, the hard disk drive 125 or a removable program medium that can be loaded or installed on the computer system 120.

The peripheral bus 131 is used to access the input, output and storage devices used by the computer 121. These input, output and storage devices include, but are not limited to, the display screen 122 the printer 123, the floppy disk drive 124, the hard disk drive 125 and the network interface 126.

The display screen 122 displays images of the melting curve data provided by the microprocessor 129 via the peripheral bus 131 or provided by other components in the computer system 120. The printer 123 provides an image on a sheet of paper or a similar type of surface. Other output devices including, but not limited to, plotters or typesetters can be used in place of, or in addition to, the printer 123.

The floppy disk drive 124 and the hard disk drive 125 are used to store various types of data. The floppy disk drive 124 facilitates transporting the data to a separate computer system while the hard disk drive 125 allows fast access to large amounts of stored data. The network interface 126 is used to send and receive data over a network that is connected to other computer systems. Those skilled in the art will recognize that other persistent storage devices to store various types of data are known in the art and are within the spirit and scope of the present invention.

All patents, patent applications, and published references cited herein are hereby incorporated herein by reference in their entirety. While the invention has been described with reference to the certain illustrated embodiments, the words which have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and materials, such as are within the scope of the appended claims.

1. A system for auctioning a flight on a fractional private charter aircraft comprising:
an online auction interface to receive a trip itinerary request from a customer;
a calculation mechanism to calculate a duration of the flight for the trip itinerary;
a query mechanism to obtain, from a fractional aircraft owner database, a set of suitable fractional aircraft owners to serve the trip itinerary based on the duration of the flight from the calculation mechanism; and
an online bidding interface to receive the bids corresponding to the suitable fractional aircraft owners from the query mechanism.

2. The system according to claim 1, wherein the online auction interface comprises a web browser on a customer computer.

3. The system according to claim 1, wherein the online auction interface comprises an auction interface on an auction computer server.

4. The system according to claim 3, wherein the auction computer server is on a web server.

5. The system according to claim 1, wherein the trip itinerary comprises a request for a certain number of flight hours.

6. The system according to claim 1, wherein the trip itinerary comprises information regarding a flight request comprising a departure location, a destination location, a type of aircraft, and desired travel dates.

7. The system according to claim 6, wherein the calculation mechanism calculates the duration of the flight from the trip itinerary using the departure location and the destination location from the trip itinerary and calculating the number of flight hours required for the trip itinerary.

8. The system according to claim 1, wherein the suitable fractional aircraft owners comprises a fractional aircraft owner who has enough flight hours to fulfill the trip itinerary based on the calculation of the duration of the flight from the calculation mechanism.

9. The system according to claim 1, wherein the online bidding interface comprises a web browser on a bidder computer.

10. The system according to claim 1, wherein the online bidding interface comprises a bidding interface on an auction computer server.

11. The system according to claim 10, wherein the auction computer server is on a web server.

12. The system according to claim 1, wherein an online bidding interface allows the customer to view the bids for the trip itinerary.

13. The system according to claim 1, further comprising a transaction mechanism which processes a transaction for the trip itinerary if a customer completes the transaction by selecting one of the bids from the fractional aircraft owners.

14. The system according to claim 13, wherein the transaction mechanism comprises an confirmation mechanism which comprises a communication to the customer at a communication address provided by the customer during the submission of the trip itinerary, confirming the booking of the aircraft for the trip itinerary.

15. The system according to claim 13, wherein the transaction mechanism comprises a notification mechanism which comprises a communication to the fractional aircraft owner that the customer has selected their aircraft from the bids to fulfill the trip itinerary.

16. The system according to claim 13, wherein the transaction mechanism comprises a payment mechanism that charges the customer the total cost of fulfilling the trip itinerary.

17. A method for auctioning a flight on a fractional private charter aircraft comprising:
receiving a trip itinerary request from a customer by an online auction interface;
calculating a duration of a flight for the trip itinerary;
obtaining, from a fractional aircraft owner database, a set of suitable fractional aircraft owners to serve the trip itinerary based on the duration of the flight;
receiving, at an online bidding interface, bids on the trip itinerary from the suitable fractional aircraft owners; and
processing a transaction for the trip itinerary if the customer completes the transaction by selecting one of the bids from the fractional aircraft owners.

18. The method according to claim 17, wherein the online auction interface comprises a web browser on a customer computer.

19. The method according to claim 17, wherein the online auction interface comprises an auction interface on an auction computer server.

20. The method according to claim 17, wherein the trip itinerary includes a departure location, a destination location, a type of aircraft, and desired travel dates.

21. The method according to claim 17, wherein the suitable fractional aircraft owners comprises a fractional aircraft owner having enough flight hours to fulfill the trip itinerary based on the duration of the flight.

22. The method according to claim 17, wherein the online bidding interface comprises a web browser on a bidder computer.

23. The method according to claim 17, wherein the online bidding interface comprises a bidding interface on an auction computer server.

24. The method according to claim 17, further comprising confirming the transaction for the trip itinerary by a communication sent to the customer at a communication address provided by the customer during the submission of the trip itinerary.

25. The method according to claim 17, further comprising notifying the fractional aircraft owner that the customer has selected their aircraft from the bids to fulfill the trip itinerary.

26. The method according to claim 17, further comprising charging the customer the total cost of the trip itinerary.

27. A computer readable medium containing program instructions for auctioning a flight on a fractional private charter aircraft comprising:
program instructions for receiving a trip itinerary request from a customer with an online auction interface;
program instructions for calculating a duration of the flight for the trip itinerary;
program instructions for obtaining, from a fractional aircraft owner database, a set of suitable fractional aircraft owners to serve the trip itinerary based on the duration of the flight from a calculation mechanism;
program instructions for receiving a set of bids from the suitable fractional aircraft owners from an online bidding interface; and
program instructions for processing a transaction for the trip itinerary if a customer completes the transaction by selecting one of the bids from the fractional aircraft owners.
